(19) United States
(12) Patent Application Publication
(10) Pub. No.: US 2016/0112461 A1
(43) Pub. Date: Apr. 21, 2016

(54) COLLECTION AND USE OF CAPTURED VEHICLE DATA

(71) Applicant: CLOUDCAR, INC., Mountain View, CA (US)

(72) Inventor: Konstantin Othmer, Los Altos, CA (US)

(21) Appl. No.: 14/982,803

(22) Filed: Dec. 29, 2015

Related U.S. Application Data
(63) Continuation of application No. 13/623,700, filed on Sep. 20, 2012.

(51) Int. Cl. H04L 29/06; G06F 21/62; G11B 27/34; H04N 7/18; G06K 9/00; G06K 9/32; H04L 29/08; G06Q 50/26

(52) U.S. Cl. CPC H04L 63/302; H04L 67/12; G06F 21/6218; H04L 63/102; G06Q 50/265; H04N 7/18; G06K 9/00771; G06K 9/3258; G11B 27/34

(57) ABSTRACT

In an example embodiment, a method of reporting observation data includes receiving, at a vehicle, a request from a server for observation data associated with at least one of an area of interest, a time period of interest, or an object of interest. The method also includes outputting a message to a user of the vehicle to request authorization to grant the server access to observation data of the vehicle. The method also includes receiving a reply to the message from the user. The method also includes, in response to the reply authorizing the server to access the observation data of the vehicle, providing the server with access to the observation data of the vehicle.

### CROSS-REFERENCE TO RELATED APPLICATIONS

This patent application is a continuation-in-part of U.S. patent application Ser. No. 13/623,700, filed Sep. 20, 2012, which is incorporated herein by reference.

### FIELD

Example embodiments described herein relate to the collection and use of observation data captured by automobiles, other vehicles, and/or other devices.

### BACKGROUND

To combat crime, many establishments, such as retail establishments, office buildings, etc. utilize video surveillance cameras to monitor their premises. Oftentimes, the output from the video camera is recorded using video recording equipment while, in other cases, security personnel view monitors from the video cameras in an effort to police the premises and reduce crime. Traditional video surveillance systems suffer from a variety of disadvantages.

For example, traditional video surveillance systems are often placed in open view on the premises. One disadvantage of openly mounted video surveillance cameras is that criminals, noting the position of the video cameras, are frequently able to evade the video camera by carefully moving around the video camera. For example, for a video camera mounted on the exterior of a building at an elevated height and facing downwardly, seasoned criminals are able to evade the camera by merely walking closely along the side of the building when they know there is a video camera mounted at an elevated height on the building.

Another disadvantage of traditional video surveillance systems is that establishments typically limit the coverage of their video surveillance systems to premises owned by or otherwise associated with the establishments. As such, many public areas and other locations may lack any video surveillance at all, possibly allowing criminal activity to occur undetected in such locations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

Some embodiments described herein generally relate to the collection and use of observation data such as video data and/or image data captured by vehicles, and/or other devices such as traffic cameras, surveillance cameras, and mobile devices including integrated cameras. In this way, each of the vehicles and other devices becomes part of a video network that can be used to, among other things, find and/or track movements of individuals, such as suspected criminals, and/or vehicles, such as vehicles involved in suspected criminal activity. Whereas the vehicles and/or other devices that capture the observation data may be ubiquitous and mobile, criminals may have a difficult time evading the cameras as the vehicles and/or other devices may be moving and/or the criminals may be unaware of exactly which vehicles are capturing observation data. The vehicles and/or other devices may also be found in many public locations and other locations lacking premises-specific surveillance systems, providing such coverage for areas that would otherwise have none.

In some embodiments, an owner or operator of the vehicle may have the ability to decide whether to grant access for a particular purpose. For example, in response to a request for access to observation data of the vehicle, the owner may see or hear a message output by the vehicle that requests authorization to grant access to the observation data of the vehicle. If the user authorizes access, law enforcement or other entities that request the access may access the observation data of the vehicle without a warrant or a subpoena.

Accordingly, in an example embodiment, a method of reporting observation data includes receiving, at a vehicle, a request from a server for observation data associated with at least one of an area of interest, a time period of interest, or an object of interest. The method also includes outputting a message to a user of the vehicle to request authorization to grant the server access to observation data of the vehicle. The method also includes receiving a reply to the message from the user. The method also includes, in response to the reply authorizing the server to access the observation data of the vehicle, providing the server with access to the observation data of the vehicle.

In another example embodiment, a non-transitory computer-readable medium has computer instructions stored thereon that are executable by a processing device to perform or control performance of operations. The operations include receiving, at a vehicle, a request from a server for observation data associated with at least one of an area of interest, a time period of interest, or an object of interest. The operations also include outputting a message to a user of the vehicle to request authorization to grant the server access to observation data of the vehicle. The operations also include receiving a reply to the message from the user. The operations also include, in response to the reply authorizing the server to access the observation data of the vehicle, providing the server with access to the observation data of the vehicle.

Alternatively or additionally, observation data captured by the vehicle may be stored securely in the vehicle and may be compressed, e.g., over time, down to data with a relatively small storage footprint. For example, the observation data may initially include video data and/or image data with a relatively large storage footprint, as well as information derived from the video data and/or the image data that may have a relatively small storage footprint. The derived information may include information about faces or license plate numbers identified in the video data and/or the image data; information about vehicles identified in the video data and/or the image data, such as vehicle colors, vehicle makes, and/or vehicle models; and/or information about the time, date, and/or location of the vehicle when the video data and/or the image data is captured, which times, dates, and/or locations may be associated with faces, license plates, and/or vehicles identified in the video data and/or the image data. In some embodiments, the observation data may be compressed down to just the derived information by aging out the large video data and/or the image data. The derived information may be stored securely in the vehicle, e.g., in one or more encrypted files. Because the derived information may have a relatively small storage footprint, it may be stored for a long time. The vehicle's observation data, including the derived information, may be interrogated on demand (e.g., via a subpoena or warrant) for a particular purpose, e.g., to look for a person or vehicle that is the subject of an AMBER alert.

Accordingly, in another example embodiment, a method of reporting observation data includes capturing first observation data by storing at least one of video data or image data generated by an imaging device of a vehicle. The method also includes capturing second observation data. Capturing second observation data includes processing the video data and/or the image data to identify at least one of a license plate number of a second vehicle included in the video data and/or the image data, a vehicle color of the second vehicle, a vehicle make of the second vehicle, or a vehicle model of the second vehicle. Capturing second observation data also includes generating the second observation data that includes the at least one of the license plate number, the vehicle color, the vehicle make, or the vehicle model, a time of observing the second vehicle, and a location where the second vehicle is observed. The method also includes storing the license plate data securely in an encrypted file. The method also includes aging out the video data and/or the image data over time. The method also includes receiving, at the vehicle, a request from a server for observation data associated with at least one of an area of interest, a time period of interest, or an object of interest. The method also includes identifying observation data of the vehicle that is associated with the at least one of the area of interest, the time period of interest, or the object of interest, the identified observation data including at least a portion of one or both of the first observation data and the second observation data. The method also includes sending the identified observation data to the server.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a diagram of an example operating environment in which some embodiments described herein may be implemented;

FIG. 1B shows an illustrative example of a server and a vehicle that may be included in the operating environment of FIG. 1A;

FIG. 2 is a block diagram of an example data capture system that may be included in the vehicle of FIGS. 1A-1B;

FIG. 3 shows an example flow diagram of a method of collecting observation data from vehicles;

FIG. 4 shows an example flow diagram of a method of reporting observation data; and

FIG. 5 shows an example flow diagram of another method of reporting observation data.

### DETAILED DESCRIPTION OF SOME EXAMPLE EMBODIMENTS

Some embodiments described herein generally relate to the collection and use of observation data such as video data and/or image data captured by vehicles, and/or other devices. For example, vehicles with backup cameras or other imaging devices may continuously capture video data while in active use, e.g., while the vehicles are running and/or being driven. While some automobiles currently manufactured have backup cameras, there is currently legislation in the United States that would require a backup camera in all new vehicles beginning in the year 2015, such that backup cameras in vehicles such as automobiles may become more and more ubiquitous. Vehicles may also or instead have a front facing camera or a camera facing any other direction relative to the vehicle that may be used to capture video data or other observation data as described herein.

A server may track locations of the vehicles and, in response to a trigger event, may identify those vehicles that are within an area of interest associated with the trigger event. The server may then send a request that the vehicles within the area of interest upload their observation data, such as the last 5 seconds of video data, to the server. Alternately, the server may send the request to a much broader subset, and possible all vehicles, where each vehicle individually decides whether or not to respond to the request based on where it was.

In some embodiments, each vehicle may request authorization from an owner or operator of the vehicle to upload the observation data requested by the server. If the owner or operator provides authorization, the vehicle may respond to the server's request by uploading the requested observation data to the server. If the owner or operator does not provide authorization, the vehicle may ignore the server's request or may respond to the server's request with an indication that the owner or operator has denied authorization to upload the requested observation data. Alternatively, if the server indicates to the vehicle that the observation data requested by the server is the subject of or related to a subpoena or warrant obtained by law enforcement, the vehicle may send the identified observation data to the server without authorization from the owner or operator of the vehicle to do so.

The uploaded observation data may be used by law enforcement or other entities to, for example, find and track people or vehicles associated with the trigger event. For example, if a victim reports a hit and run at a particular location and time, the server may request that all vehicles within a surrounding area at the particular time upload their observation data, which observation data could then be used to investigate the circumstances of the hit and run, to identify the perpetrator and/or the vehicle driven by the perpetrator, or the like or any combination thereof. In these and other embodiments, the server may be owned or operated by law enforcement or by some other entity.

The vehicles may optionally perform license plate number and/or face recognition on the captured video data and/or image data to identify vehicles and/or persons appearing in the captured video data. Corresponding license plate data and/or face data may be stored in a secure file by each vehicle. When an event happens, the server may send a request to all vehicles within an area near the event for observation data captured by the vehicles during a time period immediately before, during and/or immediately after the event. For example, suppose an event happens such as a child is abducted or a hit and run occurs and the license plate number of a vehicle involved in the abduction or the hit and run is known along with a relevant time period. A request may be sent by the server to all vehicles that were in the area near the event or other area of interest during the relevant time period. Some or all of the vehicles may search their secure files for the license plate number and, if it is found in the secure files, may respond to the server with the location and times the license plate number was observed. The response may additionally include video data and/or image data captured during or around the times the vehicles observed the license plate number.

In addition, the vehicles may be put in an active mode to immediately notify the server if the license plate or image is seen. As in the previous example of the abducted child, the server may instruct all vehicles in a given area to send up an alert if a specific license plate is seen. When this is no longer relevant, the server can send a message to the vehicles instructing them to no longer notify if the license plate is seen.

Reference will now be made to the drawings to describe various aspects of some example embodiments of the invention. The drawings are diagrammatic and schematic representations of such example embodiments, and are not limiting of the present invention, nor are they necessarily drawn to scale.

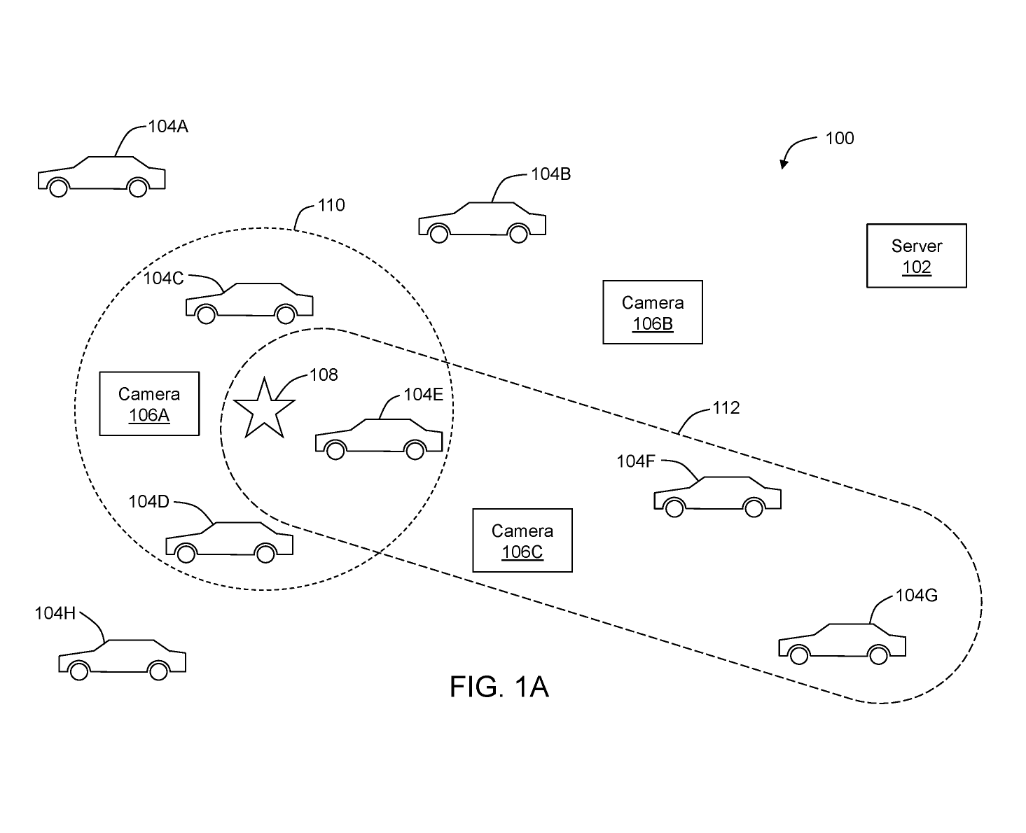

FIG. 1A is a diagram of an example operating environment 100 in which some embodiments described herein may be implemented. The operating environment 100 includes a server 102 and one or more vehicles 104A-104H (hereinafter “vehicles 104” or “vehicle 104”). The operating environment 100 may optionally further include one or more cameras 106A-106C (hereinafter “cameras 106” or “camera 106”). The server 102, the vehicles 104 and the cameras 106 may collectively form a video network, or more broadly, an information gathering network, that can be used to, for example, locate other vehicles, locate people or other objects, or provide video data or image data or other data associated with a particular area of interest, a time period of interest, and/or an object of interest.

Accordingly, and in general, each vehicle 104 is configured to capture observation data from a surrounding vicinity of each vehicle 104. For example, each vehicle 104 may include at least one camera or other imaging device to capture observation data, and perhaps other devices for capturing observation data as well. Broadly speaking, observation data includes data representing any observation of a corresponding vehicle 104. Accordingly, the observation data may include, but is not limited to, video data and/or image data captured by the imaging device of each vehicle 104, time data and/or location data captured by a clock and/or Global Positioning System (GPS) device of each vehicle 104, or the like or any combination thereof. Observation data additionally includes data derived from the foregoing to the extent such derived observation data represents an observation of the corresponding vehicle 104. Examples of derived observation data include, but are not limited to, license plate data, face data, vehicle color data, vehicle make data, vehicle model data, or the like or any combination thereof.

Video data may include one or more video streams. Image data may include one or more images. Time data may include a time stamp or stamps applied to video data or image data, for example. Location data may include a location stamp or stamps applied to video data or image data, for instance. License plate data may include a license plate number identified in image data or video data captured at the vehicle, a time of observing the license plate number (e.g., a time when the image data or video data is captured), and/or a location where the license plate number is observed (e.g., a location where the image data or video data is captured). Face data may include a face identified in image data or video data captured at the vehicle, a time of observing the face (e.g., a time when the image data or video data is captured), and/or a location where the face is observed (e.g., a location where the image data or video data is captured).

Vehicle color data may identify a vehicle color or colors of a vehicle captured in the video data or image data, a time of observing the vehicle of the identified vehicle color or colors (e.g., a time when the image data or video data is captured), and/or a location where the vehicle of the identified vehicle color or colors is observed (e.g., a location where the image data or video data is captured). Vehicle make data may identify a vehicle make (e.g., Ford, BMW, Lexus, etc.) of a vehicle captured in the video data or image data, a time of observing the vehicle of the identified vehicle make (e.g., a time when the image data or video data is captured), and/or a location where the vehicle of the identified vehicle make is observed (e.g., a location where the image data or video data is captured). Vehicle model data may identify a vehicle model of a vehicle captured in the video data or image data, a time of observing the vehicle of the identified vehicle model (e.g., a time when the image data or video data is captured), and/or a location where the vehicle of the identified vehicle model is observed (e.g., a location where the image data or video data is captured).

The vehicles 104 may have the same or different vehicle make, vehicle model, and/or year, notwithstanding all are illustrated identically in FIG. 1A for convenience. Additionally, all of the vehicles 104 are illustrated in FIG. 1A as automobiles, and specifically as cars. More generally, the vehicles 104 may include any suitable means of conveyance, such as, but not limited to, cars, trucks, motorcycles, tractors, semi-tractors, airplanes, motorized boats, drones, or the like, or even non-motorized vehicles such as bicycles, sailboats, or the like.

With continued reference to FIG. 1A, the cameras 106 are examples of non-vehicular imaging devices. Each camera 106 may be configured to capture observation data from a surrounding vicinity of each camera 106. The observation data captured by each camera 106 may be analogous to the observation data captured by the vehicles 104. Each of the cameras 106 may be provided as a discrete device such as a traffic camera or a surveillance camera, or integrated in a device such as a mobile phone, a tablet computer, a laptop computer, or other mobile device. Such standalone devices or mobile devices with integrated imaging devices may be registered by an associated user or administrator to communicate with the server 102 and/or to download software for performing various functions such as those described herein.

The server 102 is configured to track a location of each of the vehicles 104. For example, the vehicles 104 may self-report their respective locations to the server 102 on a regular or irregular basis, and/or the server 102 may poll each of the vehicles for their respective locations on a regular or irregular basis. In some embodiments, owners, operators or other individuals associated with the vehicles 104 may authorize (or not) tracking of the locations of the vehicles 104 by the server 102. Owners, operators, or other individuals associated with vehicles may sometimes be referred to generically herein as users of the vehicles.

The server 102 may be further configured to identify trigger events in response to which observation data may be collected by the server 102 from a subset of the vehicles 104 located within an area of interest of the operating environment 100 during a time period of interest. Various non-limiting examples of trigger events include America's Missing: Broadcast Emergency Response (AMBER) alerts, security alarms, fire alarms, police dispatches, and emergency calls such as 911 calls or direct calls to local police or fire departments, or the like. Such emergency calls may report a fire, a collision, and/or crimes such as a home invasion, a theft, a robbery, an abduction, or a hit and run, or the like.

Each trigger event may specify or otherwise be associated with a location of interest, a time period of interest and/or an object of interest. Locations of interest may include last known locations and/or predicted locations of people and/or vehicles identified in AMBER alerts, locations where security alarms and/or fire alarms are sounding, locations that may be specified by a caller in an emergency call such as a location of a fire, a collision, and/or a crime, or other locations specified by or otherwise associated with trigger events. An example location of interest is denoted by a star in FIG. 1A at 108.

Time periods of interest may include time periods when people and/or vehicles identified in AMBER alerts were at a last known location or are likely to be at a predicted location, a time period at least partially specified by a caller in an emergency call such as a time believed by the caller to correspond to the start or the occurrence of a fire, collision, or crime, a time period at least partially inferred from the trigger event and including a current time when no time period is explicitly specified, when a security alarm or fire alarm is currently sounding and/or when a caller is reporting a fire, collision or crime that is currently in progress, or the like or any combination thereof.

Objects of interest may include people, vehicles, or other objects involved in or specified by a trigger event, such as a suspected abductor, an abductee and/or a vehicle specified in an AMBER alert, houses or other buildings or structures where a fire alarm or security alarm is sounding, vehicles involved in a collision or crime that is the subject of an emergency call, alleged perpetrators or victims of a crime, or the like.

In response to identifying a trigger event, the server 102 is further configured to identify a subset of the vehicles 104 that are located within an area of interest during the time period of interest specified by or otherwise associated with the trigger event. The area of interest may be determined from the location of interest 108. For example, the area of interest may include a substantially circular area centered on the location of interest 108. An example of a substantially circular area of interest is denoted in FIG. 1A at 110. For the discussion that follows, it is assumed that FIG. 1A illustrates locations of the vehicles 104 during the time period of interest, which information is available to the server 102.

Alternately or additionally, the area of interest may include a projected path of travel of an object of interest specified by or otherwise associated with the trigger event, or multiple potential paths of travel of the object of interest. An example of an area of interest including a projected path of travel is denoted in FIG. 1A at 112. Alternately or additionally, the area of interest may include a particular city, neighborhood, zip code, etc. in which the location of interest 108 is located.

The area of interest may be determined by the server 102 taking any of a variety of factors into account, including, but not limited to, the nature of the trigger event, map data, or other suitable factors. Alternately, the area of interest may be selected by an administrator of the server 102 and/or specified or associated with the trigger event, or the like. For simplicity in the discussion that follows, it is assumed that the circular area 110 is the area of interest (hereinafter “area of interest 110”) associated with the location of interest 108.

Based on location data maintained by the server 102, the server 102 identifies the vehicles 104C-104E as being located within the area of interest 110 during the time period of interest. In embodiments where cameras 106 are also provided, the server 102 may also identify the camera 106A as being located within the area of interest 110 during the time period of interest. The server sends a request to each of the vehicles 104C-104E and/or the camera 106A for observation data captured by each within the area of interest 110 during the time period of interest. Alternately or additionally, the server 102 may be configured to determine a direction each of the vehicles 104C-104E and/or the camera 106A is facing during the time period of interest and may send the request only to those vehicles 104C-104E and/or the camera 106A determined to be facing the location of interest 108 or other direction of interest. For example, if the server 102 determines that only the vehicle 104E and the camera 106A are facing a direction of interest, the server 102 may send the request to the vehicle 104E and the camera 106A without sending the request to the vehicles 104C-104D.

Alternately or additionally, the vehicles 104 may silently (e.g., without reporting) and securely track their own locations locally at each vehicle 104 as observation data including vehicle locations over time, such that the server 102 may or may not also track locations of the vehicles 104. In these and other embodiments, the server 102 may send requests to a much broader subset than only those vehicles 104C-104E within the area of interest 110. For example, the server 102 may send requests to potentially all of the vehicles 104. Each of the vehicles 104 may then individually decide whether to respond to requests based on where it was, as indicated by the corresponding observation data including vehicle locations over time.

As previously indicated, a user of each vehicle 104 may determine whether to respond to requests for observation data received from the server 102. The user may set and/or adjust one or more settings of the corresponding vehicle 104 so that the vehicle 104 is automatically authorized (or not) by the user to always (or never) provide observation data requested by the server 102.

Alternatively, the settings of the corresponding vehicle 104 may be set and/or adjusted so the vehicle 104 requests, for each request received from the server 102, authorization from the user to provide requested observation data to the server 102 in response to the request from the server 102 or to otherwise grant the server 102 access to observation data of the vehicle 104. In these and other embodiments, the vehicle 104—or a vehicle component such as an audio system and/or head unit with a display—may output a message to the user that requests the authorization. For instance, the vehicle 104 may output a message such as “The police are looking for a green Ford Mustang with license plate ABCDEFG. Grant access to your vehicle's car history to help?” More generally, the message output to user may include a request to access the captured observation data of the vehicle 104 for a particular purpose that may or may not be specified in the message.

In response to the message output by the vehicle 104 requesting authorization to access the captured observation data of the vehicle 104, the user may input a response to the message through an input device included in the vehicle 104 or a component thereof. For example, the audio system and/or the head unit with the display may include a microphone, button, touchscreen display, or other input device(s) through which the user may input a response to the message. If the response authorizes access to the captured observation data of the vehicle 104, the vehicle 104 may send the requested observation data to the server 102 or otherwise allow the server 102 to access the requested observation data. The server 102, which may be owned, operated, or otherwise associated with law enforcement or some other entity, may provide the observation data received from the vehicle 104 to law enforcement. Accordingly, some embodiments described herein may permit law enforcement to collect observation data from one or more of the vehicles 104 without a warrant or a subpoena.

In other embodiments, the user may refuse to authorize access to the captured observation data of the vehicle 104. In these and other embodiments, law enforcement may attempt to access the captured observation data of the vehicle 104 by first obtaining a warrant or a subpoena to access the captured observation data of the vehicle 104. In these and other embodiments, if the server indicates to the vehicle 104 that requested observation data is the subject of or is otherwise related to a subpoena or warrant, the vehicle 104 may send the requested observation data to the server 102 or otherwise grant the server 102 access to observation data of the vehicle 104 without authorization from the user.

FIG. 1B shows an illustrative example of the server 102 and the vehicle 104E that may be included in the operating environment 100 of FIG. 1A. As illustrated, the server 102 sends a request 114 to the vehicle 104E and the vehicle 104E sends a response 116 to the server 102. In some embodiments, the vehicle 104E may receive the request 114 without sending the response 116 if, for example, the vehicle 104E does not have any observation data from the time period of interest and/or of the area of interest, or if the user refuses to authorize access by the server to observation data of the vehicle 104E, or for other reasons.

The illustrated request 114 includes a license plate number 118 corresponding to a vehicle of interest that the server 102 may be looking for in this example. However, FIG. 1B is not mean to be limiting. For example, the request 114 can include, but is not limited to; a number N identifying a last N time period (e.g., the last 5 seconds) of video data and/or image data for the vehicle 104E to upload to the server 102; a license plate number, a vehicle color, a vehicle make, and/or a vehicle model associated with a vehicle of interest; a face of a person of interest; information identifying some other object of interest; or an instruction to automatically upload to the server 102 any information captured in the future by the vehicle 104E relating to the license plate number/vehicle color/vehicle make/vehicle model, the face, or other object of interest specified in the request 114, or the like or any combination thereof.

The illustrated response 116 includes one or more times 120, one or more locations 122, and video and/or image data 124. For example, in response to receiving the request 114 identifying the license plate number 118, the vehicle 104E may include in the response 116 the time(s) 120 and location(s) 122 where the vehicle 104E has observed the license plate number 118. Optionally, the vehicle 104E may further include in the response 116 video data and/or image data 124 captured when the license plate number 118 was observed and/or the response 116 may include the license plate number 118 itself.

In a similar manner, many thousands, or even millions of vehicles 104 may report when and where they see the license plate number 118 (or other object of interest) identified in the request 114. Moreover, the amount of data in the response 116 may be relatively small, such as less than a few kilobytes, especially where the video and/or image data 124 is omitted and the response 116 merely includes the time(s) 120, location(s) 122 and/or the identified license plate number 118. Thus, even thousands or millions of vehicles 104 reporting when and where they see the license plate number 118 may result in relatively little data traffic in some embodiments.

FIG. 1B is not meant to be limiting. More generally, the response 116 can include any observation data captured by the vehicle 104E. The captured observation data can include, but is not limited to, a particular license plate number, vehicle color, vehicle make, vehicle model, face or other object, one or more times when the license plate number, vehicle color, vehicle make, vehicle model, face or other object was observed, one or more locations where the license plate number, vehicle color, vehicle make, vehicle model, face or other object was observed, image data, video data, or the like or any combination thereof.

In these and other embodiments, the server 102 may include a communication interface 102A, a vehicle tracking module 102B, an identification module 102C, and/or a collection and sharing module 102D. The communication interface 102A may include a wireless interface such as an IEEE 802.11 interface, a Bluetooth interface, or a Universal Mobile Telecommunications System (UMTS) interface, an electrical wired interface, an optical interface, or the like or any combination thereof. Additionally, the communication interface 102A may be configured to facilitate communication with the vehicles 104 to send requests 114 and receive responses 116 and/or to collect location data from the vehicles 104. The communication interface 102A may be further configured to facilitate communication with other entities such as entities from which trigger events may be provided.

The vehicle tracking module 102B is configured to track locations of the vehicles 104 and/or the cameras 106. For instance, the vehicle tracking module 102B may generate and regularly update a table of locations with the most current location data received from the vehicles 104 and/or the cameras 106. Alternately, in some embodiments in which the vehicles 104 track their own locations silently and securely, for example, the vehicle tracking module 102B may be omitted from the server 102.

The identification module 102C is configured to identify trigger events and/or vehicles 104 located within areas of interest during time periods of interest.

The collection and sharing module 102D is configured to collect observation data uploaded by the vehicles 104 and to share the collected observation data with law enforcement and/or other entities.

Although not shown, the server 102 may additionally include a computer-readable storage medium and a processing device. The computer-readable storage medium may include, but is not limited to, a magnetic disk, a flexible disk, a hard-disk, an optical disk such as a compact disk (CD) or DVD, and a solid state drive (SSD) to name a few. Another example of a computer-readable storage medium that may be included in the mobile device 302 may include a system memory (not shown). Various non-limiting examples of system memory include volatile memory such as random access memory (RAM) or non-volatile memory such as read only memory (ROM), flash memory, or the like or any combination thereof. The processing device may execute computer instructions stored on or loaded into the computer-readable storage medium to cause the server 102 to perform one or more of the functions described herein, such as those described with respect to the vehicle tracking module 102B, the identification module 102C and/or the collection and sharing module 102D.

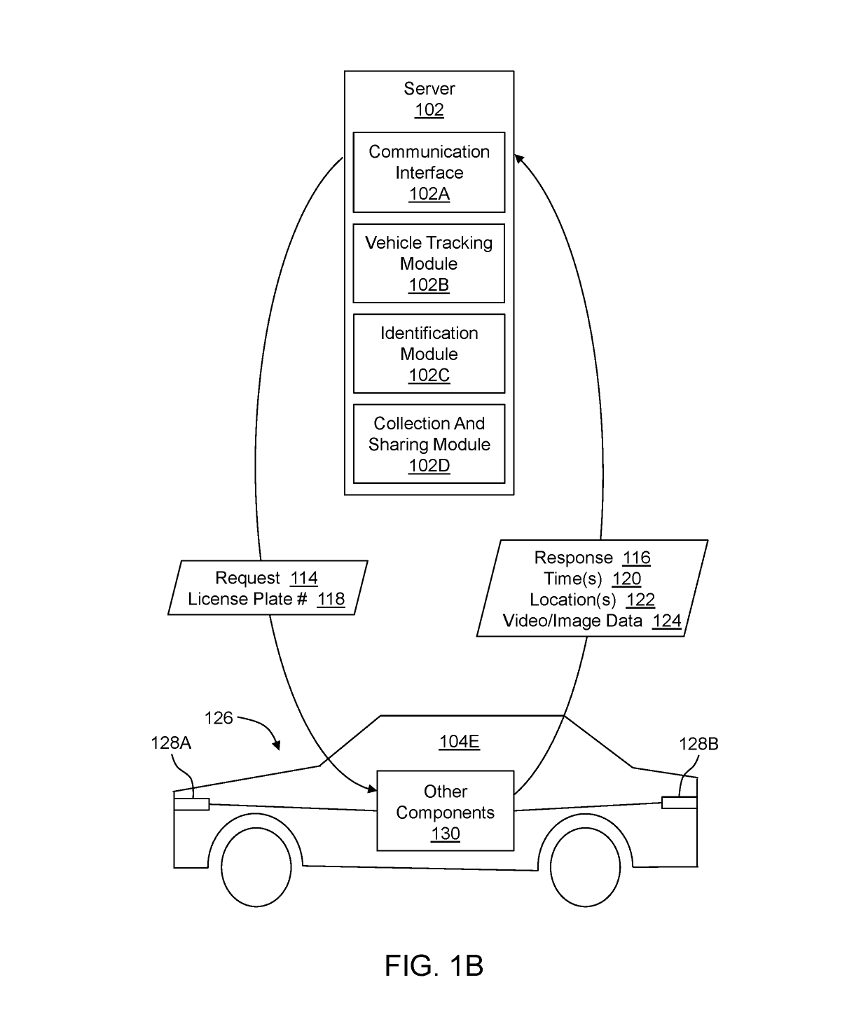

As illustrated in FIG. 1B, the vehicle 104E includes a data capture system 126 including one or more imaging devices 128A-128B (hereinafter “imaging devices 128”) and one or more other components 130, as described in more detail with respect to FIG. 2. In general, the imaging devices 128 are configured to generate video data and/or image data that may be processed by the other components 130. The imaging device 128B may include a backup camera of the vehicle 104E. As mentioned previously, backup cameras may become increasingly ubiquitous in vehicles beginning in the year 2015 due to legislation. Thus, some embodiments described herein use a backup camera or other imaging device provided in the vehicle 104E for backing up or some other reason unrelated to video surveillance and repurpose the backup camera for a reason unrelated to its original reason.

The other components 130 additionally receive requests 114 from the server 102 and send responses 116 to the server 102, determine and report location data to the server 102, output messages to a user of the vehicle 104E, receive input from the user, or the like or any combination thereof.

FIG. 2 is a block diagram of an example data capture system 200 that may be included in the vehicle 104E (or any of the vehicles 104) of FIGS. 1A-1B. The data capture system 200 may correspond to the data capture system 126 of FIG. 1B, for instance. As illustrated, the data capture system 200 includes an imaging device 202 that may correspond to the imaging devices 128 of FIG. 1B. Although a single imaging device 202 is illustrated in FIG. 2, more generally the data capture system 200 may include any number of imaging devices 202. In some embodiments, the imaging device 202 includes a backup camera of a vehicle in which the data capture system 200 is included.

The data capture system 200 additionally includes one or more other components 204, 206, 208 210 that may correspond to the other components 130 of FIG. 1B, including a computer-readable storage medium 204, a processing device 206, a communication interface 208 and a Global Positioning System (GPS) device 210. Although not illustrated in FIG. 2, a computer bus and/or other means may be provided for communicatively coupling the components 202, 204, 206, 208, 210 together.

The computer-readable storage medium 204 generally stores computer-executable instructions that may be executed by the processing device 206 to cause the data capture system 200 to perform the operations described herein. The computer-readable storage medium 204 may additionally store observation data captured by the data capture system 200 as described in more detail below.

The imaging device 202 is configured to generate video data such as a video stream and/or image data such as one or more still images. The video data and/or the image data may be stored in the computer-readable storage medium as video data 212 and image data 214. The video data 212 and the image data 214 are examples of observation data that may be captured by the data capture system 200 and more generally by a corresponding vehicle in which the data capture system 200 may be installed. The imaging device 202 may include one or more charge-coupled devices (CCDs), active pixel sensors (APSs), or other suitable image sensor devices.

The video data 212 and/or the image data 214 may be tagged with location data and/or time data (e.g., as a location stamp(s) and/or a time stamp(s)) by the GPS device 210 and/or a clock device (not shown). The location data and time data are other examples of observation data that may be captured by the data capture system 200.

Other data may be derived from the video data 212 and/or the image data 214 and saved in the computer-readable storage medium 204 as observation data. In these and other embodiments, license plate number recognition and/or face recognition may be performed on the video data and/or the image data 214. For example, the video data 212 and/or the image data 214 may be processed, e.g., by the processing device 206, to identify license plate numbers, faces, or other objects of interest in the video data 212 and/or the image data 214. Alternatively or additionally, image processing may be performed on the video data and/or the image data to identify a vehicle color, a vehicle make, and/or a vehicle model of one or more vehicles captured in the video data and/or the image data. For example, the image data 214 and/or video data 212 may be processed to identify one or more words, logos, or other features on a vehicle of interest that indicate the vehicle make and/or vehicle model of the vehicle.

A secure file 216, such as an encrypted file, may be used to store identification 216A of such license plate numbers, faces, or other objects of interest. In some embodiments, such data is stored in the secure file 216 to allay concerns about privacy. The identification 216A may include data representing the license plate number, face, or other object of interest. The secure file 216 may additionally include one or more observation times 216B of the corresponding license plate number, face, or other object of interest, a vehicle color, vehicle make, and/or vehicle model of a vehicle to which the license plate was attached, and one or more observation locations 216C of the corresponding license plate number, face, or other object of interest. The times 216B and/or locations 216C may be generated by the GPS device 210 and/or a clocking device before being saved to the secure file 216 on the computer-readable storage medium 204.

Accordingly, license plate data including a license plate number, a time of observing the license plate number, and/or location where the license plate number is observed and respectively corresponding to the identification 216A, times 216B and locations 216C may thereby be stored in the secure file 216. Analogously, face data including a face of a person, a time of observing the face, and/or location where the face is observed and respectively corresponding to the identification 216A, times 216B and locations 216C may thereby be stored in the secure file 216. Alternatively or additionally, vehicle color data, vehicle make data, and/or vehicle model data, including a corresponding vehicle color/make/model, a time of observing the vehicle with the vehicle color/make/model, and/or a location where the vehicle with the vehicle color/make/model is observed and respectively corresponding to the identification 216A, times 216B and locations 216C may thereby be stored in the secure file 216. The license plate data, face data, vehicle color data, vehicle make data, and/or vehicle model data stored in the computer-readable storage medium 204 are other examples of observation data that may be captured by the data capture system 200.

One of skill in the art will appreciate, with the benefit of the present disclosure, that the amount of data in the secure file 216 may be relatively small. For example, the amount of data to store a history (e.g., location and time) in the secure file 216 for a given license plate may be less than about a hundred bytes. Thus, the amount of data to store identifications 216A, times 216B and locations 216C even for an extensive months-long history or longer of numerous license plates, faces, or other objects of interest may be on the order of or even less than hundreds of megabytes. Moreover, at least in the case of license plates, video data of a license plate may not typically be as interesting as simply knowing where the license plate was at what times as such information can indicate likely places where the license plate will go again, as well as correlating travel and actions with a bigger story. Thus, even where storage constraints or other reasons lead to aging out the video data 212 and/or the image data 214 as described below, an extensive history of license plates, faces, or other objects of interest may be retained in the secure file 216 with a relatively small storage footprint in the computer-readable storage medium 204.

The communication interface 208 may include a wireless interface such as an IEEE 802.11 interface, a Bluetooth interface, or a Universal Mobile Telecommunications System (UMTS) interface, an electrical wired interface, an optical interface, or the like or any combination thereof. Additionally, the communication interface 208 may be configured to facilitate communication with the server 102 to receive requests and send responses and/or to provide location data to the server 102 and/or to facilitate communication with one or more input and/or output devices through which output may be provided to and/or input may be received from a corresponding user of a vehicle in which the data capture system 200 is provided.

Accordingly, when a request for observation data is received from the server 102 via the communication interface 208, the processing device 206 may be configured to identify captured observation data associated with an area of interest, a time period of interest, and/or an object of interest associated with the request received from the server. Any relevant captured observation data in the computer-readable storage medium 204 may then be sent to the server 102 via the communication interface 208. In some embodiments, the relevant captured observation data is sent to the server 102 only after requesting and receiving authorization from the vehicle's user to do so. Alternately or additionally, the processing device 206 may first determine, based on vehicle location data over time for the vehicle in which the data capture system 200 is installed, whether the vehicle was in the area of interest during the time period of interest and may send relevant captured observation data to the server 102. Alternately or additionally, the request may identify a license plate, face or other object of interest for which the vehicle currently lacks any observation data. However, the vehicle may subsequently identify the license plate, face or other object of interest and may subsequently send license plate data, face data or other relevant observation data to the server 102 when the license plate, face or other object is identified.

Due to storage constraints or for other reasons, in some embodiments, the captured observation data in the computer-readable storage medium 204 may be aged out. For example, the video data 212 and/or the image data 214 may be recorded in a loop such that the newest video data 212 and/or image data 214 is written over the oldest video data 212 and/or image data 214 after an allotted storage capacity is full. Alternately or additionally, video frames of the video data 212 may be selectively deleted from time to time to gradually reduce a frame rate of the video data over time such that older video data 212 has a lower frame rate than newer video data. Alternately or additionally, video data 212 and/or image data 214 having an age greater than a selected threshold may be completely deleted.

In still other embodiments, the captured observation data may be aged out by identifying events of interest. Events of interest may include, but are not limited to, braking the vehicle harder than a corresponding braking threshold, accelerating the vehicle faster than a corresponding acceleration threshold, cornering the vehicle faster than a corresponding cornering threshold, colliding with an object, or running over an object. Portions of the video data 212 and/or the image data 214 associated with (e.g., concurrent with) the identified events may be tagged. Different standards may be applied for aging out tagged video data 212 and/or tagged image data 214 than for aging out non-tagged video data 212 and/or non-tagged image data 214. For instance, tagged video data 212 and/or tagged image data 214 may be stored indefinitely or for a longer period of time than for non-tagged video data 212 and/or non-tagged image data 214.

In some embodiments, data in the secure file 216 may be subject to a different age out period than the video data 212 and/or the image data 214 since data in the secure file 216 may take up relatively little storage space, as described above. Alternately or additionally, the data in the secure file 216 may not be aged out at all even where the video data 212 and/or the image data 214 is aged out.

In an example embodiment, observation data that initially includes image data 214, video data 212, identification 216A (e.g., license plate data, face data, vehicle color/make/model data, etc.), time 216B, and/or location 216C may be compressed (e.g., over time according to an age out process) to just the identification 216A, time 216B, and/or location 216C. For instance, after compression, the remaining information may include license plate data, time 216B, location 216C, and/or possibly other relevant information like vehicle color/make/model data. The remaining information may be stored securely in memory of the vehicle, e.g., as the secure file 216. Insofar as secure files such as the secure file 216 may collectively have a relatively small storage footprint as already described, such data may be stored at the vehicle for a long time. The data may be interrogated later on demand (e.g., via a subpoena) for a particular purpose, e.g., to look for an Amber Alert violator or other object of interest.

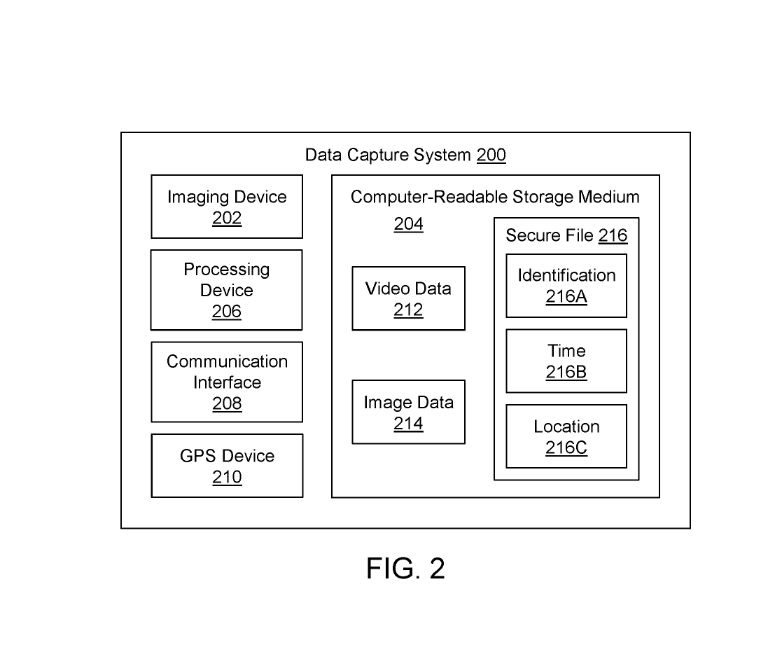

FIG. 3 shows an example flow diagram of a method 300 of collecting observation data from vehicles. The method 300 and/or variations thereof may be implemented, in whole or in part, by a server such as the server 102 of FIGS. 1A-1B. Alternately or additionally, the method 300 and/or variations thereof may be implemented, in whole or in part, by a processing device executing computer instructions stored on a computer-readable storage medium. Although illustrated as discrete blocks, various blocks may be divided into additional blocks, combined into fewer blocks, or eliminated, depending on the desired implementation.

The method may begin at block 302 in which a request is sent to each vehicle in a plurality of vehicles for observation data associated with at least one of an area of interest, a time period of interest, or an object of interest. For instance, the request may be sent by the communication interface 102A of the server 102 of FIG. 1A. The request may include any of the data described above with respect to the request 114 of FIG. 1B, for example.

In block 304, observation data is received from one or more of the plurality of vehicles. The observation data may be captured by the one or more of the plurality of vehicles and may be associated with the at least one of the area, the time period, or the object. Additionally, the observation data may be received via the communication interface 102A at the collection and sharing module 102D of the server 102 of FIG. 1A, for instance. The received observation data may include video data captured by one of the vehicles, including a time sequence of images of the area of interest and/or of one or more objects within the area of interest during the time period of interest. Alternately or additionally, the received observation data may include image data captured by one of the vehicles, including at least one image of the area of interest and/or of one or more objects within the area of interest during the time period of interest. Alternately or additionally, the received observation data may include license plate data, face data, vehicle color data, vehicle make data, or vehicle model data, or the like or any combination thereof.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 300 may additionally include, prior to sending the request, identifying a trigger event, where sending the request at 302 occurs in response to identifying the trigger event. Various non-limiting examples of trigger events are described above.

Alternately or additionally, the plurality of vehicles may include a first plurality of vehicles. In these and other embodiments, prior to sending the request, the method 300 may further include tracking a location of each of a second plurality of vehicles. The method 300 may additionally include identifying a subset of the second plurality of vehicles located within the area during the time period. The subset may include the first plurality of vehicles. The request may be sent exclusively to the subset including the first plurality of vehicles located within the area during the time period.

Alternately or additionally, the vehicles may silently track their own locations as described above. For example, the observation data captured by each of the vehicles may include locations of the corresponding vehicle over time. In these and other embodiments, each of the vehicles may be configured to determine whether it was located within the area during the time period based on the locations of the corresponding vehicle over time. Those vehicles determined to have been within the area during the time period may then send the requested observation data.

In some embodiments, the method 300 may further include identifying a subset of multiple non-vehicular imaging devices registered with the server 102 and located within the area of interest during the time period of interest. The cameras 106 of FIG. 1A are examples of such non-vehicular imaging devices. The request for observation data may also be sent to each of the non-vehicular imaging devices in the subset.

Alternately or additionally, the method 300 may include indicating in the requests sent to the plurality of vehicles, or in separate communications sent to the plurality of vehicles, that a subpoena or warrant has been obtained by law enforcement for the requested observation data. In some embodiments, when communications sent to the plurality of vehicles indicate that the subpoena or warrant has been obtained for the requested observation data, the vehicles may be configured to provide the requested observation data (provided they have it) whether or not they have been authorized to do so by a corresponding user.

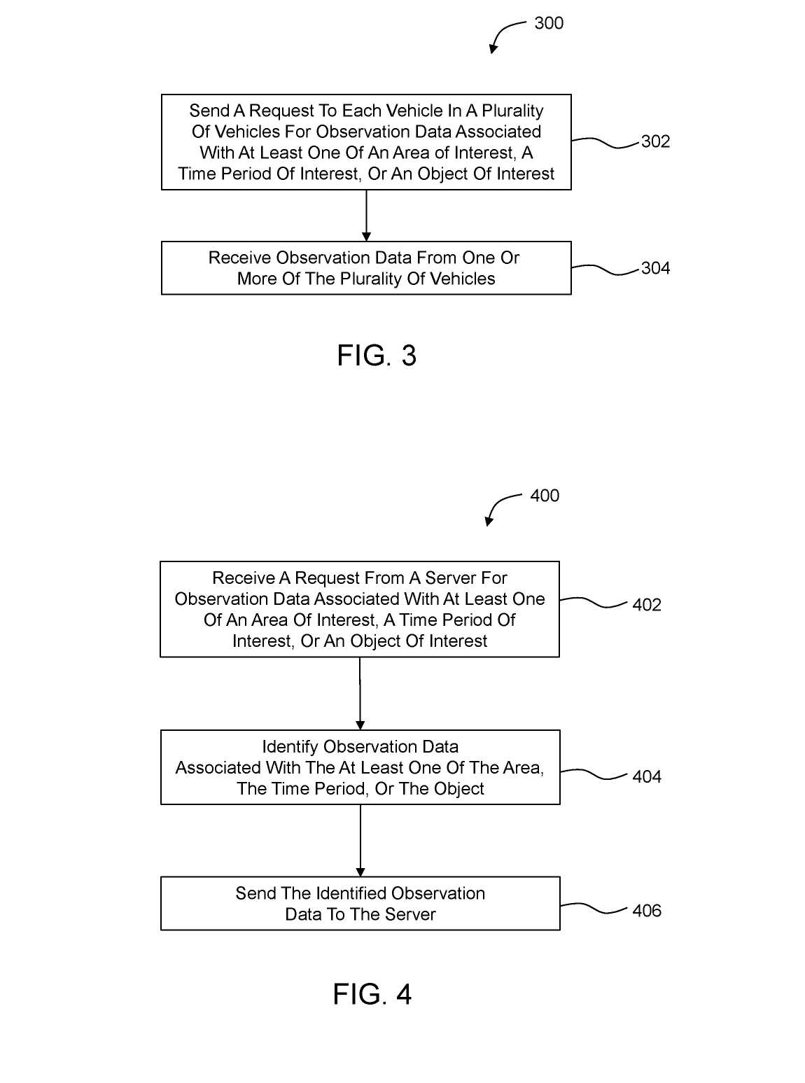

FIG. 4 shows an example flow diagram of a method 400 of reporting observation data. The method 400 and/or variations thereof may be implemented, in whole or in part, by a vehicle such as any of the vehicles 104 of FIGS. 1A-1B, or more particularly by a data capture system such as may be included in the vehicle such as the data capture system 200 of FIG. 2. Alternately or additionally, the method 400 and/or variations thereof may be implemented, in whole or in part, by a processing device executing computer instructions stored on a computer-readable storage medium. Although illustrated as discrete blocks, various blocks may be divided into additional blocks, combined into fewer blocks, or eliminated, depending on the desired implementation.

The method may begin at block 402 in which a request is received from a server for observation data associated with at least one of an area of interest, a time period of interest, or an object of interest. The request may be received at a vehicle. For instance, such a request may be received via the communication interface 208 of the data capture system 200 of FIG. 2 installed in the vehicle from a server such as the server 102 of FIGS. 1A-1B. The object of interest may include a second vehicle or a person and the request may include a license plate number, vehicle color, vehicle make, and/or vehicle model associated with the second vehicle or a face of the person, or more particularly, data identifying the license plate number, the vehicle color, the vehicle make, the vehicle model, and/or the face of the person.

In block 404, observation data is identified that is associated with the at least one of the area of interest, the time period of interest, or the object of interest. For example, the vehicle may search through the video data and/or the image data for video data and/or image data that has been tagged with time data and/or location data that indicates the video data and/or the image data was captured during the time period of interest and/or within the area of interest. Alternately or additionally, the vehicle may search through captured observation data for a license plate number, vehicle color, vehicle make, vehicle model a face of the person, or other feature of the object of interest that may be specified in the request received from the server as an object of interest or as a feature of the object of interest.

In block 406, the observation data identified as being associated with the at least one of the area of interest, the time period of interest, or the object of interest is sent to the server.

Although not shown, the method 400 may further include capturing observation data prior to receiving the request. In these and other embodiments, capturing observation data may include storing at least one of video data or image data generated by at least one imaging device associated with the vehicle. The identified observation data may include at least a portion of the video data or image data. The method 400 may further include aging out video data and/or image data. Various examples of how the video data and/or the image data may be aged out are provided above.

Alternately or additionally, the method 400 may further include capturing observation data, including processing video data and/or image data captured by the vehicle to identify a license plate number, and generating license plate data including the license plate number, a time of observing the license plate number, and a location where the license plate number is observed. In these and other embodiments, sending the identified observation data to the server may include sending one or more of the license plate data and at least some of the video data and/or image data to the server. Alternately or additionally, the identified observation data sent to the server at 406 may include the license plate data.

The license plate data may be captured and securely stored in an encrypted file in a computer-readable storage medium of the vehicle with other license plate data corresponding to other license plate numbers prior to receiving the request. Alternately, the request may include the license plate number as the object of interest and the identified observation data including the license plate data may be sent to the server in response to identifying the license plate number in the video data and/or image data substantially in real time.

Alternately or additionally, the method 400 may further include capturing observation data, including processing video data and/or image data captured by the vehicle to identify a face, and generating face data including the face, a time of observing the face, and a location where the face is observed. In these and other embodiments, sending the identified observation data to the server may include sending one or more of the face data and at least some of the video data and/or image data to the server. Alternately or additionally, the identified observation data sent to the server at 406 may include the face data.

The face data may be captured and securely stored in an encrypted file in a computer-readable storage medium of the vehicle with other face data corresponding to other faces prior to receiving the request. Alternately, the request may include the face or data identifying the face as the object of interest and the identified observation data including the face data may be sent to the server in response to identifying the face in the video data and/or image data substantially in real time.

Alternately or additionally, the method 400 may further include capturing observation data, including processing video data and/or image data captured by the vehicle to identify a vehicle color, vehicle make, and/or vehicle model, and generating vehicle color data, vehicle make data, and/or vehicle model data including an identification of the vehicle color, the vehicle make, and/or the vehicle model, a time of observing the vehicle, and a location where the vehicle is observed. In these and other embodiments, sending the identified observation data to the server may include sending one or more of the vehicle color data, the vehicle make data, and/or the vehicle model data to the server. Optionally, at least some of the video data and/or image data may also be provided to the server.

The vehicle color data, the vehicle make data, and/or the vehicle model data may be captured and securely stored in an encrypted file in a computer-readable storage medium of the vehicle with other such data corresponding to other vehicles prior to receiving the request.

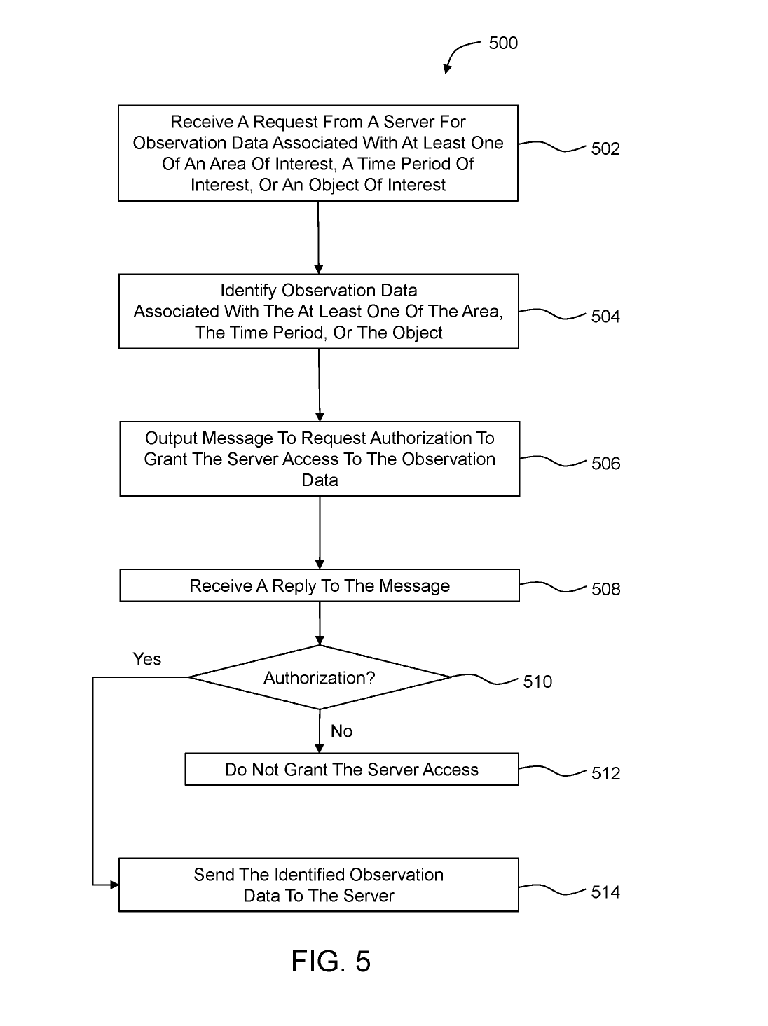

FIG. 5 shows an example flow diagram of another method 500 of reporting observation data. The method 500 and/or variations thereof may be implemented, in whole or in part, by a vehicle such as any of the vehicles 104 of FIGS. 1A-1B, or more particularly by a data capture system such as may be included in the vehicle such as the data capture system 200 of FIG. 2. Alternately or additionally, the method 500 and/or variations thereof may be implemented, in whole or in part, by a processing device executing computer instructions stored on a computer-readable storage medium. Although illustrated as discrete blocks, various blocks may be divided into additional blocks, combined into fewer blocks, or eliminated, depending on the desired implementation.

The method may begin at block 502 in which a request is received from a server for observation data associated with at least one of an area of interest, a time period of interest, or an object of interest. The request may be received at a vehicle. For instance, such a request may be received via the communication interface 208 of the data capture system 200 of FIG. 2 installed in the vehicle from a server such as the server 102 of FIGS. 1A-1B. The object of interest may include a second vehicle or a person and the request may include a license plate number, vehicle color, vehicle make, and/or vehicle model associated with the second vehicle or a face of the person, or more particularly, data identifying the license plate number, the vehicle color, the vehicle make, the vehicle model, and/or the face of the person.

In block 504, observation data is identified that is associated with the at least one of the area of interest, the time period of interest, or the object of interest. For example, the vehicle may search through the video data and/or the image data for video data and/or image data that has been tagged with time data and/or location data that indicates the video data and/or the image data was captured during the time period of interest and/or within the area of interest. Alternately or additionally, the vehicle may search through captured observation data for a license plate number, vehicle color, vehicle make, vehicle model a face of the person, or other feature of the object of interest that may be specified in the request received from the server as an object of interest or as a feature of the object of interest.

In block 506, a message may be output to user of the vehicle to request authorization from the user to grant access to the observation data to the server. Outputting the message may include outputting the message through a speaker within the vehicle or through a display device within the vehicle.

In block 508, a reply to the message may be received from the user, which reply may grant or withhold authorization for the server to access the observation data of the vehicle. Receiving the reply may include receiving input of the user through an input device of the vehicle.

At block 510, the vehicle may determine whether the reply grants or withholds authorization. For example, possible replies to the message may be binary, e.g., “yes” or “no.” The “yes” reply may be associated with a first input and the “no” reply may be associated with a second input. If the input received through the input device includes the first input, it may be determined that the reply is “yes,” which may authorize the server to access the observation data of the vehicle. On the other hand, if the input received through the input device includes the second input, it may be determined that the reply is “no,” which may withhold authorization for the server to access the observation data of the vehicle.

In block 512, and in response to the reply withholding authorization (“No” at block 510), the vehicle may not grant the server access to the vehicle's observation data.

In block 514, and in response to the reply granting authorization (“Yes” at block 510), the observation data identified as being associated with the at least one of the area of interest, the time period of interest, or the object of interest is sent to the server. Alternately or additionally, the vehicle may otherwise grant the server access to all observation data of the vehicle, some observation data of the vehicle, and/or only the identified observation data.

The operations of the method 500 of FIG. 5 may be implemented in different order than illustrated in FIG. 5, some operations may be omitted altogether, or other operations may be added. For example, the identification of the observation data at block 504 may be omitted altogether in some embodiments.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media may include tangible computer-readable storage media including RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of reporting observation data, the method comprising:
receiving, at a vehicle, a request from a server for observation data associated with at least one of an area of interest, a time period of interest, or an object of interest;
outputting a message to a user of the vehicle to request authorization to grant the server access to observation data of the vehicle;
receiving a reply to the message from the user; and
in response to the reply authorizing the server to access the observation data of the vehicle, providing the server with access to the observation data of the vehicle.

2. The method of claim 1, wherein the user comprises an owner or operator of the vehicle.

3. The method of claim 1, wherein the message output to the user includes an explanation of a purpose for which access to the observation data of the vehicle is requested by the server, the explanation being received in the request from the server.

4. The method of claim 1, wherein the message output to the user includes a description of a second vehicle that is the object of interest, the description of the second vehicle including at least one of a vehicle color, a vehicle make, or a vehicle model of the second vehicle, the description being received in the request from the server.

5. The method of claim 1, further comprising identifying observation data of the vehicle that is associated with the at least one of the area of interest, the time period of interest, or the object of interest, wherein providing the server with access to the observation data of the vehicle comprises sending the identified observation data of the vehicle to the server.

6. The method of claim 5, wherein providing the server with access to the observation data of the vehicle consists of sending the identified observation data of the vehicle to the server, the method further comprising:
receiving a second request from the server for second observation data associated with at least one of a second area of interest, a second time period of interest, or a second object of interest;
outputting a second message to the user to request authorization to grant the server access to the observation data of the vehicle;
receiving a reply to the second message from the user; and
in response to the reply to the second message withholding authorization for the server to access the observation data of the vehicle, withholding any of the observation data of the vehicle that is associated with the at least one of the second area of the interest, the second time period of interest, or the second object of interest from the server.

7. The method of claim 1, further comprising:
receiving, at the vehicle, a second request from the server for second observation data associated with at least one of a second area of interest, a second time period of interest, or a second object of interest;
receiving, at the vehicle, an indication from the server that a subpoena or warrant has been obtained by law enforcement for the requested second observation data; and
in response to the indication from the server that the subpoena or warrant has been obtained for the requested second observation data, granting the server access to observation data of the vehicle without authorization from the user to grant the server access.

8. A non-transitory computer-readable medium having computer instructions stored thereon that are executable by a processing device to perform operations comprising:
receiving, at a vehicle, a request from a server for observation data associated with at least one of an area of interest, a time period of interest, or an object of interest;
outputting a message to a user of the vehicle to request authorization to grant the server access to observation data of the vehicle;
receiving a reply to the message from the user; and
in response to the reply authorizing the server to access the observation data of the vehicle, providing the server with access to the observation data of the vehicle.

9. The non-transitory computer-readable medium of claim 8, wherein the user comprises an owner or operator of the vehicle.

10. The non-transitory computer-readable medium of claim 8, wherein the message output to the user includes an explanation of a purpose for which access to the observation data of the vehicle is requested by the server, the explanation being received in the request from the server.

11. The non-transitory computer-readable medium of claim 8, wherein the message output to the user includes a description of a second vehicle that is the object of interest, the description of the second vehicle including at least one of a vehicle color, a vehicle make, or a vehicle model of the second vehicle, the description being received in the request from the server.

12. The non-transitory computer-readable medium of claim 8, the operations further comprising identifying observation data of the vehicle that is associated with the at least one of the area of interest, the time period of interest, or the object of interest, wherein providing the server with access to the observation data of the vehicle comprises sending the identified observation data of the vehicle to the server.

13. The non-transitory computer-readable medium of claim 12, wherein providing the server with access to the observation data of the vehicle consists of sending the identified observation data of the vehicle to the server, the operations further comprising:
receiving a second request from the server for second observation data associated with at least one of a second area of interest, a second time period of interest, or a second object of interest;
outputting a second message to the user to request authorization to grant the server access to the observation data of the vehicle;
receiving a reply to the second message from the user; and
in response to the reply to the second message withholding authorization for the server to access the observation data of the vehicle, withholding any of the observation data of the vehicle that is associated with the at least one of the second area of the interest, the second time period of interest, or the second object of interest from the server.

14. The non-transitory computer-readable medium of claim 8, the operations further comprising:
receiving, at the vehicle, a second request from the server for second observation data associated with at least one of a second area of interest, a second time period of interest, or a second object of interest;
receiving, at the vehicle, an indication from the server that a subpoena or warrant has been obtained by law enforcement for the requested second observation data; and
in response to the indication from the server that the subpoena or warrant has been obtained for the requested second observation data, granting the server access to observation data of the vehicle without authorization from the user to grant the server access.

15. A method of reporting observation data, the method comprising:
capturing first observation data by storing at least one of video data or image data generated by an imaging device of a vehicle;
capturing second observation data, comprising:
processing the video data and/or the image data to identify at least one of a license plate number of a second vehicle included in the video data and/or the image data, a vehicle color of the second vehicle, a vehicle make of the second vehicle, or a vehicle model of the second vehicle; and
generating the second observation data that includes the at least one of the license plate number, the vehicle color, the vehicle make, or the vehicle model, a time of observing the second vehicle, and a location where the second vehicle is observed;
storing the license plate data securely in an encrypted file;
aging out the video data and/or the image data over time;
receiving, at the vehicle, a request from a server for observation data associated with at least one of an area of interest, a time period of interest, or an object of interest;
identifying observation data of the vehicle that is associated with the at least one of the area of interest, the time period of interest, or the object of interest, the identified observation data including at least a portion of one or both of the first observation data and the second observation data;
sending the identified observation data to the server.

16. The method of claim 15, wherein:
the request is generated by the server in response to an America's Missing Broadcast Emergency Response (AMBER) alert;
the observation data requested by the server is associated with the object of interest; and
the object of interest includes a person or vehicle specified by the AMBER alert.

17. The method of 15, wherein the server indicates to the vehicle that the requested observation data is the subject of a subpoena or warrant and sending the identified observation data to the server comprises sending the identified observation data to the server without authorization from an owner or operator of the vehicle to do so.

18. The method of claim 15, wherein the server does not indicate to the vehicle that the requested observation data is the subject of a subpoena or warrant, the method further comprising receiving authorization from an owner or operator of the vehicle to grant the server access to observation data of the vehicle prior to sending the identified observation data to the server.

19. The method of claim 15, wherein aging out the video data and/or the image data over time comprises at least one of:
recording the video data and/or the image data in a loop;
selectively deleting video frames of the video data to gradually reduce a frame rate of the video data over time such that older video data has a lower frame rate than newer video data;
completely deleting video data and/or image data having an age greater than a selected threshold; or
identifying events of interest, tagging video data and/or image data associated with the identified events, and applying a different standard for aging out tagged video data and/or tagged image data than for aging out non-tagged video data and/or non-tagged image data.

20. The method of claim 15, wherein the vehicle comprises a drone.
